(19) United States
(12) Patent Application Publication
(10) Pub. No.: US 2007/0271317 A1
(43) Pub. Date: Nov. 22, 2007

(54) System and Method for the Synchronization of Data Across Multiple Computing Devices

(75) Inventor: Sharon Carmel, Givatayim (IL)

Correspondence Address: BROOKS KUSHMAN P.C., 1000 TOWN CENTER, TWENTY-SECOND FLOOR, SOUTHFIELD, MI, 48075, US

(73) Assignee: BEINSYNC LTD., Tel Aviv (IL)

(21) Appl. No.: 11/573,794

(22) PCT Filed: Aug. 16, 2005
(86) PCT No.: PCT/IL05/00889

§ 371 Date: Feb. 16, 2007

Related U.S. Application Data
(60) Provisional application No. 60/601,620, filed on Aug. 16, 2004.

(51) Int. Cl. G06F 17/30

(52) U.S. Cl. 707/204; 707/201; 707/E17.005

(57) ABSTRACT

Disclosed are a method and an apparatus for synchronizing data from a synchronization module or application to one or more associated synchronization modules or applications. According to some embodiments of the present invention, a data item may be created in response to an action executed on a data unit. The data item may be associated with a unique or a substantially unique identifier The unique identifier associated with the data item may be included in an activity log which may be created in response to an action executed on the data unit. The activity log may further include an ascending log number The activity log may be propagated to one or more of the associated synchronization applications or modules.

### CROSS REFERENCE TO RELATED APPLICATIONS

This application claims the benefit of prior U.S. provisional patent application No. 60/601,620 filed Aug. 16, 2004, the contents of which are hereby incorporated by reference in their entirety.

### FIELD OF THE INVENTION

The present invention relates generally to the fields of computing and communications. More specifically, the present invention relates to a system and method for the synchronization of data across two or more computing devices or platforms, where changes made to the data on one device may be propagated to any number of other devices.

### BACKGROUND

No one can argue that computers, computing systems, and data communication networks have changed the way in which people live, work, play and communicate. Some have even gone so far as to state that distributed communications network, made possible by modern computing and communication devices, are responsible for the greatest sociological paradigm shift since the industrial revolution. For example, due to the proliferation of modern computing devices and distributed communication networks, which are capable of carrying voice, video, data, and various other formats of communication, many modern workers have been freed from having to be located at any fixed point or location in order to accomplish their day to day tasks. Telecommuting and online collaboration are ever increasing trends.

Along with the benefits that come with being able to work from one or multiple computing devices located in any one of a number of places, there come certain complications and drawbacks which have not yet been sufficiently addressed. Namely, since mobile users may use multiple devices, it may be difficult and/or tedious work to synchronize data across all the devices a person may use, thus allowing access to the most up to date data when and where it is required. Since data may be scattered (e.g. replicated) over different devices and locations, changes to data made on one device may not be propagated to a second or third device used by the same user, and thus when the user attempts to access the altered data from another device, the data may not be up-to-date. This same problem may be faced by a group of people who are collaboratively working on and sharing certain data. Changes made by one group member on a data unit on his or her device may not be reflected on a copy of the data unit residing on a second group member's device, and thus group members may find themselves out of sync, working of diverging documents.

Although there are some solutions which have attempted to the address the above mentioned problem, such as Virtual Private Networks (“VPNs”) to allow remote access, these solutions are complex, expensive, and force users to actively connect to a server before proceeding. These solutions do not allow offline access and, since data is not replicated, do not automatically keep a backup of the users' data. Therefore, there is a need for a solution which will allow users to work seamlessly across multiple devices (e.g. PC, laptop, PDA, mobile phone), residing in multiple locations (e.g. home, office, on the go) while maintaining all their desired data (e.g. files, pictures, emails, etc.) available to them at all time. Furthermore, there is a need for a solution which will allow users to transfer data to others and/or collaborate with other users in a shared environment. There is a need for each of the above mentioned solutions to be operable both when a user's device is connected (e.g. online), through a communication network, to other devices in the collaborative environment, and just as importantly when the user's device is not connected (e.g. offline).

### SUMMARY OF THE INVENTION

Some embodiments of the present invention relate to an apparatus and a method of synchronizing data from a synchronization application or module to one or more associated synchronization applications or modules. In accordance with some embodiments of the present invention, a method of synchronizing data from a synchronization application to one or more associated synchronization applications may include, creating a data item in response to an action executed on a data unit, and in a particular embodiment, in response to a non-data-deleting action executed on a data unit. The data item may be associated with a unique or a substantially unique identifier. In accordance with some embodiments of the present invention, the method of synchronizing data from a synchronization application to one or more associated synchronization applications may further include, creating an activity log in response to an action executed on the data unit. In accordance with an embodiment of the present invention, the activity log may be created in response to a non-data-deleting action or in response to a data-deleting action executed on the data unit. The activity log may include the substantially unique identifier associated with the data item and an ascending log number. The activity log may be propagated to one or more of the associated synchronization applications. In accordance with further embodiments of the present invention, the log may or may not be implemented (for example, the activity log may be discarded) as will be discussed in greater detail hereinbelow.

In accordance with some embodiments of the present invention, an apparatus for synchronizing data from a synchronization module to one or more associated synchronization modules may include a synchronization module adapted to create a data item and being further adapted to create an activity log. In accordance with some embodiments of the present invention, the synchronization module may be adapted to create the data item in response to an action executed on a data unit, and in accordance with one embodiments of the present invention, in response to a non-data-deleting action executed on the data unit. The synchronization module may be adapted to associate the data item with a substantially unique identifier. In accordance with some embodiments of the present invention, the synchronization module may be further adapted to create the activity log in response to an action executed on the data unit. In accordance with one embodiment of the present invention, the synchronization module may be adapted to create the activity log in response to a non-data-deleting action or in response to a data-deleting action executed on the data unit. As part of the creation of the activity log or immediately thereafter, the synchronization module may be adapted to associate the activity log with the substantially unique identifier associated with the data item and with an ascending log number. The synchronization module may be adapted to cause the activity log to be propagated to one or more of the associated synchronization modules.

According to some embodiments of the present invention, a synchronization module (or a specific agent performing a corresponding action implemented as part of the synchronization module) running on a first computing device may monitor the activity of one or more data sources and/or software applications also running on the device (e.g. file management system, email client, word processing application, spreadsheet application, etc.) and the synchronization module (or a specific agent performing this action implemented as part of the synchronization module) may record in an activity log data associated with an action performed on any data unit (e.g. file, email, text document, spreadsheet, etc.) associated with the one or more data sources and/or software applications.

According to some embodiments of the present invention, the term data source may refer to a file management system, for example the Windows XP operating system's file managements system or possibly a file management system coupled to an enterprise resource management application. According to some embodiments of the present invention, the term data source may refer to one or a set of file directories managed by a file management system. The term data source may also refer to a specific software application which may produce and/or store data, and/or any combination of data sources mentioned above.

Each data output (e.g. file, email, image, etc.) from a data source may be assigned or otherwise associated with a data unit, and each record in the activity log may relate to, or otherwise be associated with, the creation, amendment or alteration, and deletion of a given data unit. Each activity log record relating to a given data unit may include a reference to a data item associated with the data unit's. A data item may be associated with a unique identifier (or a substantially unique identifier) for each data unit it is associated with, A data item may be associated with or represent any data unit type, for example, a text document, spreadsheet, email, picture, browser favorites link, etc. A data item within may be associated with or represent different versions of the data unit (e.g. document, spreadsheet, email, etc.).

Corresponding data units (e.g. documents, emails, internet favorites, etc.) may be defined as data units shared or otherwise collaboratively used on two or more devices. A data unit may correspond to a data unit or any version of that data unit. According to some embodiments of the present invention, each data unit and each data item associated with each data unit may be assigned or associated with an identification string or identifier, and log entries relating to activity on a given data unit may include the unique identifiers of the data the data item associated with the given data unit.

An action, which as a result of the execution thereof a data unit is deleted may be referred also as a “data-deleting action”. An action, which as a result of the execution thereof, a new data unit is created and/or an existing data unit is altered and/or an existing data unit's metadata is altered, and/or any of an existing data unit's properties is altered may be referred to as a “non-data-deleting action”.

In accordance to some embodiments of the present invention a new data item record may be created only for non-data-deleting actions executed on a data unit. It also should be noted that in some embodiments of the present invention, a data item record may only be updated as a result of a non-data-deleting actions executed on a data unit.

In some embodiments of the present invention, actions executed on a data unit including data-deleting and/or non-data-deleting actions may result in the creation of a new log record. It should also be noted that in accordance to some embodiments of the present invention, for cases synchronization software requirements is not to synchronize certain changes on certain data-deleting and/or non-data-deleting actions a log activity record can be omitted and synchronization for such change whose log record is omitted may not occur.

It should also be noted that, in some cases of data-deletion actions executed on a data unit, the data item associated with the data unit may be deleted and/or additional data items associate with the data item may be deleted and/or some or all of the data items associated with the deleted data item may also be deleted and /or some or all of the data units associated with the data items may be deleted.

According to some further embodiments of the present invention, each record in a data items table may be associated with a single data item and may include fields indicating various characteristics of the data item, including but not limited to the item's unique identifier, and lineage (i.e. identifier or parent and/or children items). Additional fields, such as the source application type and the synchronization module data type, as well as additional fields related to the handling of the items by the synchronization module, may be included; such additional fields may be referred to as “data item family”. Each time a data unit is created, a new data item associated with the new data unit may be created and a unique data item identifier may be also be created and assigned to the data item. Furthermore, a new record associated with the. new data item, including the new item's identifier, may be inserted into the data items table.

According to some embodiments of the present invention, a data item may contain data correlated with a specific version of the data unit to which the data item is associated. For example, if the data unit is a text document, the first data item to be created and associated with the unit/document may include content correlated to some or all of the content of the document/unit, as created (e.g. the content itself or just a link to the content in the data source).

According to some embodiments of the present invention, when an existing data unit is amended or otherwise altered, a new data item, with a new unique identifier, may be created and the new data item may be associated with the altered version of the data unit and may include content correlated to the content of the altered data unit. For example, the new data item may include some or all of the content of the altered data unit, or may include only the delta or differences between the original and altered versions of the content in the data unit, or may include a link to the content in its data source.

According to a further embodiment of the present invention, a data item may not contain actual content correlated with the content of the specific version of the data unit with which it is associated, but may rather include a link or pointer to a file or physical location in memory where the relevant content may reside. For example, if a new data unit (e.g. document file) is created, an associated data item may also be created, where the associated data item may include, amongst other information, a link back to the physical file containing content correlated with the content of the new data unit, or in some cases the data unit itself. Should an existing data unit be altered, another data item may be created and associated to the altered version of the data unit, and the new data item may include, amongst other information, a link or pointer back to the physical file containing content correlated with the content of the altered data unit, or in some cases the altered data unit itself.

A new record may be entered into the data items table each time a new data item is created, whether the data item is created as the result of a new data unit or the alteration of an existing data unit. In the event the new data item is the result of an alteration to an existing data unit, which data unit had a data item associated with its previous version, the new data items table record for the new data item may contain the unique identifier of the new data item along with the unique identifier of the parent data item from which it, the new child data item, was derived. According to some embodiments of the present invention, each data item may include an indicator as to the unique identifier(s) of its parent data item and/or of its child data items.

According to some embodiments of the present invention, a synchronization module running on a computing device may be associated with one or more synchronization modules, each running on a separate associated computing device. Each of the synchronization modules may have a unique identifier. In accordance with further embodiments of the present invention, each of the activity log records may include an owner or an originator or a creator field including the unique identifier of the synchronization module that created the log, or each of the activity log records may be otherwise associated with the unique identifier. In accordance with some embodiments of the present invention, each of the synchronization modules may be associated with a communication module to facilitate communication across a data communication network (e.g. the internet) between it and each of the other associated synchronization modules. According to some embodiments of the present invention, a registration server and/or gatekeeper, connected to the communication network, may provide each synchronization module with information sufficient to establish a communication and synchronization session (e.g. I.P. address, port number, etc.) with other associated synchronization modules connected to the network. According to some embodiments of the present invention, the server may facilitate such services as DNS, authentication, authorization, establishing a secured connection between the devices, and various other services, not all of which must relate to synchronization. The server may also determine which device is allowed to connect to which other device based on load balancing policies and considerations.

According to some embodiments of the present invention, during synchronization between associated devices, via their respective synchronization modules, a first synchronization module may request from a second synchronization module log records related to corresponding data units on both devices. In the event that the two synchronization modules previously communicated and synchronized, the first synchronization module may request from the second synchronization module only new log records, which new log records were created in the device of the second synchronization module after the most recent previous synchronization between the first and second synchronization modules. According to some embodiments of the present invention, the second synchronization module may also request new log records from the first synchronization module.

In accordance with some embodiments of the present invention, each synchronization module may be configured to save or update the last log number it successfully received from the other synchronization module. Each synchronization module may also be configured save the last log number successfully transferred to the other synchronization module. In accordance with some embodiments of the present invention, saving the last log number and the last log number successfully transferred may enable each synchronization module to resume synchronization from the last successful log transfer.

In accordance with some embodiments of the present invention, each synchronization module may include a peers table. The synchronization module may be configured to save or update in the peers table an entry for each of the peers it previously synchronized with, either directly or indirectly, an indication relating to the log number(s) which were thus far received or successfully synchronized. In accordance with further embodiments of the present invention, the synchronization module may be configured to save or update in the peers table an entry for each of the peers it previously synchronized with, either directly or indirectly, an indication relating to the highest log numbers which was so far received or successfully synchronized with that peer.

In accordance with some embodiments of the present invention, whenever a activity log is received at any of the synchronization modules, the receiving synchronization module may be configured to check the synchronization log to determine whether the log creator and the transmitting party are associated with the same identifier. In accordance with some embodiments of the present invention, if the synchronization module determines that the log creator and the transmitting party are associated with the same identifier, the receiving synchronization module may be configured to save or update the data relating to the highest log number received for the particular synchronization module from which the log was received from (the transmitting synchronization module). However, in accordance with some embodiments of the present invention, if the receiving synchronization module determines that in accordance with the data in the creator or originator field of the received activity log, the synchronization module which created the activity log is not the transmitting synchronization module from which the activity log was received and which is correlated with the identifier associated with the received activity log, the receiving synchronization module may be configured to create or update a peer table entry associated with the synchronization module which created the activity log. In accordance with further embodiments of the present invention, in addition, the synchronization module may be configured to save or update the last log number it successfully received from the synchronization module which created the activity log. The receiving synchronization module may be configured to save or update in the peers table with the data associated with the synchronization module which created the activity log in addition to saving or updating the data relating to the transmitting synchronization module from which the activity was log was received at the receiving synchronization module.

Log records or entries received by a first synchronization module, running on a first device, from a second synchronization module, running on a second associated device, may be interpreted and the action(s) which was the source of each log record on the second device may be performed by the synchronization module on the first device. For example, if the first synchronization module receives from the second module a log record indicating the creation of a new data item unit (e.g. a new email was received or a new document was originated) on the second device, the first synchronization module may either request a copy of the data item whose content is correlated with the content of the new data unit, or may request access to the data item containing a pointer or link to a file or memory location containing the content correlated the new data unit. According to either of the above mentioned embodiments or methods, the received log record may contain the unique identifier of the relevant data item and the first computing device may utilize the identified data item to copy content correlated with the content of the new data unit from the second device to the first computing device and to create a corresponding (e.g. same) data unit on the first computing device.

According to some embodiments of the present invention, if the first synchronization module receives from the second module a log entry indicating the deletion of a data unit from the second device, the first synchronization module may delete the corresponding (e.g. same) data unit on the first computer. Also, if the first module receives from the second module a log entry indicating the amendment or alteration of a document or file represented by a data unit, the first synchronization module may use the data item indicted in the received activity log to retrieve content correlated with the altered data unit. The synchronization module of the first device may retrieve the content by retrieving the indicated data item itself, when the indicated data item includes the content, or by retrieving a file or stored memory from the second computing device to which the data item is pointing to, when the indicated data item is only a pointer or link.

According to some embodiments of the present invention, a data item referred to or indicated by an activity log record is not transferred to the device receiving the activity log record. According to such embodiments of the present invention, only the unique. identifier of the data item associated with a given log record is transferred, either along with or as part of the activity log record. If the receiving synchronization module requires access to content referred to in a received log record, the synchronization module on the receiving device request may request the content from the synchronization module on transmitting device by providing the relevant data item's unique identifier. In turn, the synchronization module may either transmit content included in the relevant data item, if the data item includes that content, or it may locate the relevant content by following a pointer or link in the identified data item, when the data item is merely a link or pointer.

According to some embodiments of the present invention, not all alterations to a data unit may require or result in the creation of a new data item. If an alteration is made to a data unit prior to that data unit's associated data item being propagated (i.e. the data item itself or any log record containing the data item's unique identifier) to other devices, production of a new data item may not be required. In such cases, only amendments to the existing data item, in accordance with the amendments made to the data item's associated data unit, may be required. According to some embodiments of the present invention, a given data unit may require a new associated data item only when the data unit is altered after the device on which the unit resides has engaged in at least one synchronization process. Otherwise, the data item may be altered multiple times without the need to create a new data item. Furthermore, changes such as file name changes or any other changes to a data unit's property not associated directly with the content of data unit may also not require a new data item.

According to some embodiments of the present invention, data associated with a log record received by a first device from a second device may be recorded as a log record in a log of the first device. A log record associated with a received log record may include the unique identifier of the synchronization module that created that log.

A log record received by one device from a second device may pass the log record to a third device, and so on. Regardless of whether a log record is received from a device which originated the log record or from a device which is merely passing along a received log record, a device receiving the log record may store the received record along with an identifier of the synchronization module that created that log. Thus, according to some embodiments of the present invention, if an activity log is propagated through a group of associated devices (or through a group of associated synchronization modules), for example, an activity log which is received at a receiving device from a transmitting device which is not the creator of the activity log, but rather received the activity log, directly or indirectly, from another device which originally created that activity log, the receiving device may be configured to check the identifier of the device which originated or created the activity log and the log number of that activity log in the device which created the activity log. As mentioned above, data relating to both the identifier of the device which originated or created the activity log and the log number of that activity log in the device which created the activity log may be included as part of each activity log received.

In accordance with some embodiments of the present invention, the receiving device or the receiving synchronization module may be adapted to determine in accordance with the identifier of the device which originated or created the activity log included in each activitiy log, whether the receiving device and the device that created the log have the same unique identifier, in which case, the synchronization module (or device) may be configured to ignore the received activity log. In accordance with further embodiments of the present invention, the receiving synchronization module may be adapted to determine in accordance with the identifier of the device which originated or created the activity log and the log number of that activity log in the originating device, whether the data in the peer table associated with the originating device indicates that the log number relating to the last successfully synchronized log already received, either directly or indirectly, from that originating device is lower than the activity log number in the device which created the received activity log, in such cases, the receiving synchronization module may be adapted to implement the log, otherwise the receiving module may be configured to ignore the received activity log.

In accordance with further embodiments of the present invention, the receiving synchronization module may be adapted to determine in accordance with the identifier of the device which originated or created the activity log and the log number of that activity log in the originating device, whether this activity log was already implemented by the receiving module. In accordance with further embodiments of the present invention, the receiving synchronization module may consult its peer table to determine whether a received activity log was already implemented by the receiving module. In accordance with yet further embodiments of the present invention, in case a receiving synchronization module determines that a certain activity log was already implemented by the receiving synchronization module, the synchronization module may consult its peer table to determine which is the highest log number associated with the synchronization module which generated the implemented activity log. Once, the receiving synchronization module determines which is the highest log number which is associated with the synchronization module which generated the implemented activity log, the receiving synchronization module may be configured to request the transmitting synchronization module to transmit (to the receiving module) only activity logs whose originating synchronization module log number is greater than the highest log number associated with the originating synchronization module which was implemented in the receiving module.

According to some embodiments of the present invention, should actions to be taken on a given data unit indicated by a received log record conflict with actions already taken locally on the corresponding data unit, the synchronization module on the receiving device may store all the available options for the resolution of the conflict and may prompt a user to resolve the conflict when the user attempts to access the document or file associated with the data unit.

It should be clear to one of ordinary skill in the art that the present invention is not limited to synchronization between two synchronization modules, but that one synchronization module may communicated and synchronize with a countless number of associated synchronization modules, either one at a time, or according to some embodiments of the present invention in parallel. A group of associated devices, each having a synchronization modules, may synchronize corresponding files or data items among all the devices of the group by propagating changes to the data items between devices, either two devices at a time, or according to some embodiments, by propagating changes made on a first device to several other devices in parallel.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is a conception diagram illustrating how, according to some embodiments of the present invention, a each of a group of associated computing device may initiate a synchronization process with another associated computer, wherein as part of the synchronization process each computing device may access a registration server and/or gatekeeper so as to obtain connection information relating to one or more of the other computing devices;

FIG. 1B is a conception diagram illustrating how, according to some embodiments of the present invention, each of a group of associated computing device may synchronize with one or more other computing devices in the group, on a peer-to-peer basis, without an intermediate server;

FIG. 2 is a block diagram illustrating various components of an exemplary data synchronization system according to some embodiments of the present invention;

FIG. 3A is flow chart diagram illustrating the steps of an exemplary method of operating data tables, logs and items to be used during synchronization, on a computing device in response to the creation of a new data file on the computing device, according to some embodiments of the present invention;

FIG. 3B is flow chart diagram illustrating the steps of an exemplary method of operating data tables, logs and items to be used during synchronization, on a computing device in response to the alteration of an existing data file on the computing device, according to some embodiments of the present invention;;

FIG. 3C is flow chart diagram illustrating the steps of an exemplary method of operating data tables, logs and items to be used during synchronization, on a computing device in response to the creation of a deletion of a data file on the computing device, according to some embodiments of the present invention;

FIGS. 4 is a conceptual block diagram illustrating an exemplary flow of data between two computing devices engaging in a synchronization process, according to some embodiments of the present invention;

FIG. 5A is a flow diagram illustrating the steps of an exemplary method of synchronizing corresponding data between two associated computing devices, according to some embodiments of the present invention;

FIG. 5B is a flow diagram illustrating the steps of an exemplary method of resolving certain conflicts as part of the synchronization of corresponding data between two associated computing devices, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a system and method of synchronizing corresponding data across two or more computing devices. According to some embodiments of the present invention, a synchronization module (or a specific agent performing a corresponding action implemented as part of the synchronization module) running on a first computing device may monitor the activity of one or more data sources and/or software applications also running on the device (e.g. file management system, email client, word processing application, spreadsheet application, etc.) and the synchronization module (or a specific agent performing a corresponding action implemented as part of the synchronization module) may record in an activity log data associated with an action performed on any data unit (e.g. file, email, text document, spreadsheet, etc.) associated with the one or more data sources and/or software applications.

According to some embodiments of the present invention, the term data source may refer to a file management system, for example the Windows XP operating system's file managements system or possibly a file management system coupled to an enterprise resource management application. According to some embodiments of the present invention, the term data source may refer to one or a set of file directories managed by a file management system. The term data source may also refer to a specific software application which may produce and/or store data, and/or any combination of data sources mentioned above.

Each data output (e.g. file, email, image, etc.) from a data source may be assigned or otherwise associated with a data unit, and each record in the activity log may relate to, or otherwise be associated with, the creation, amendment or alteration, and deletion of a given data unit. Each activity log record relating to a given data unit may include a reference to a data item associated with the data unit. A data item may be associated with the unique identifier (or a substantially unique identifier) of the data unit with which it is associated. A data item may be associated with or represent any data unit type, for example, a text document, spreadsheet, email, picture, browser favorites link, etc. A data item within may be associated with or represent different versions of the data unit (e.g. document, spreadsheet, email, etc. . . . ).

Corresponding data units (e.g. documents, emails, internet favorites, etc.) may be defined as data units shared or otherwise collaboratively used on two or more devices. The term “data unit” as used herein and throughout the specification and the claims, unless specifically stated or clearly apparent otherwise, may be used to refer to a data unit or to any version of that data unit. According to some embodiments of the present invention, each data unit and each data item associated with each data unit may be assigned or associated with a unique identification string or identifier, and log entries relating to activity on a given data unit may include the unique identifiers of the data the data item associated with the given data unit.

An action, which as a result of the execution thereof, a data unit is deleted may be referred also as a “data-deleting action”. An action, which as a result of the execution thereof, a new data unit is created and/or an existing data unit is altered and/or an existing data unit's metadata is altered, and/or any of an existing data unit's properties is altered may be referred to as a “non-data-deleting action”.

In accordance to some embodiments of the present invention a new data item record may be created only for non-data-deleting actions executed on a data unit. It should be also noted that in some embodiments of the present invention, a data item record may only be updated as a result of a non-data-deleting action executed on a data unit.

In some embodiments of the present invention, actions executed on a data unit including data-deleting and/or non-data-deleting actions may result in the creation of a new log record. It should also be noted that in accordance with some embodiments of the present invention, in cases where the synchronization software requirements are not to synchronize certain changes on certain data-deleting and/or non-data-deleting actions a log activity record can be omitted and synchronization for such change whose log record is omitted will not occur. For Example, the synchronization module can be configured not to synchronize file property such as “hidden”, in such case changing the file property to “hidden” on one of the devices will not generate a log record and the file will be hidden only on the computer the action was taken and not the other devices.

It should also be noted, that, in accordance with some embodiments of the present invention, in some cases of data-deletion actions executed on a data unit, the data item associated with the data unit may be deleted and/or additional data items associate with the data item may be deleted and/or some or all of the data items associated with the deleted data item may also be deleted and/or some or all of the data units associated with the data items may be deleted.

According to some further embodiments of the present invention, each record in a data items table may be associated with a single data item and may include fields indicating various characteristics of the data item, including but not limited to the item's unique identifier, and lineage (i.e. identifier or parent and/or children items). Each time a data unit is created, a new data item associated with the new data unit may be created and a unique data item identifier may be also be created and assigned to the data item. Furthermore, a new record associated with the new data item, including the new item's identifier, may be inserted into the data items table.

According to some embodiments of the present invention, a data item may contain data correlated with a specific version of the data unit to which the data item is associated. For example, if the data unit is a text document, the first data item to be created and associated with the unit/document may include content correlated to some or all of the content of the document/unit, as created (e.g. the content itself or just a link to the content in the data source).

According to some embodiments of the present invention, a data item may include additional fields, such as the source application type and the synchronization module data type, as well as additional fields related to the handling of the items by the synchronization module which may be included in the data item. Throughout the specification and the claims, such additional fields may be referred to as “data item family” or “data item family fields”.

According to some embodiments of the present invention, when an existing data unit is amended or otherwise altered, a new data item, with a new unique identifier, may be created and the new data item may be associated with the altered version of the data unit and may include content correlated to the content of the altered data unit. For example, the new data item may include some or all of the content of the altered data unit, or may include only the delta or differences between the original and altered versions of the content in the data unit, or may include a link to the content in its data source.

According to a further embodiment of the present invention, a data item may not contain actual content correlated with the content of the specific version of the data unit with which it is associated, but may rather include a link or pointer to a file or physical location in memory where the relevant content may reside. For example, if a new data unit (e.g. document file) is created, an associated data item may also be created, where the associated data item may include, amongst other information, a link back to the physical file containing content correlated with the content of the new data unit, or in some cases the data unit itself. Should an existing data unit be altered, another data item may be created and associated to the altered version of the data unit, and the new data item may include, amongst other information, a link or pointer back to the physical file containing content correlated with the content of the altered data unit, or in some cases the altered data unit itself.

A new record may be entered into the data items table each time a new data item is created, whether the data item is created as the result of a new data unit or the alteration of an existing data unit. In the event the new data item is the result of an alteration to an existing data unit, which data unit had a data item associated with its previous version, the new data items table record for the new data item may contain the unique identifier of the new data item along with the unique identifier of the parent data item from which it, the new child data item, was derived. According to some embodiments of the present invention, each data item may include an indicator as to the unique identifier(s) of its parent data item and/or of its child data items.

According to some embodiments of the present invention, a synchronization module running on a computing device may be associated with one or more synchronization modules, each running on a separate associated computing device. Each of the synchronization modules may have a unique identifier. In accordance with further embodiments of the present invention, each of the activity log records may include an owner or an originator or a creator field including the unique identifier of the synchronization module that created the log, or each of the activity log records may be otherwise associated with the unique identifier. In accordance with some embodiments of the present invention, each of the synchronization modules may be associated with a communication module to facilitate communication across a data communication network (e.g. the internet) between it and each of the other associated synchronization modules. According to some embodiments of the present invention, a registration server and/or gatekeeper, connected to the communication network, may provide each synchronization module with information sufficient to establish a communication and synchronization session (e.g. I.P. address, port number, etc.) with other associated synchronization modules connected to the network. According to some embodiments of the present invention, the server may facilitate such services as DNS, authentication, authorization, establishing a secured connection between the devices, and various other services, not all of which must relate to synchronization. The server may also determine which device is allowed to connect to which other device based on load balancing policies and considerations.

According to some embodiments of the present invention, during synchronization between associated devices, via their respective synchronization modules, a first synchronization module may request from a second synchronization module log records related to corresponding data units on both devices. In the event that the two synchronization modules previously communicated and synchronized, the first synchronization module may request from the second synchronization module only new log records, which new log records were created in the device of the second synchronization module after the most recent previous synchronization between the first and second synchronization modules. According to some embodiments of the present invention, the second synchronization module may also request new log records from the first synchronization module.

In accordance with some embodiments of the present invention, each of the synchronization modules may be configured to save or update the last log number it successfully received from any of the other synchronization modules (e.g., any of the synchronization modules with which it is associated). Each of the synchronization modules may also be configured to save the last log number successfully transferred to the other synchronization module. In accordance with some embodiments of the present invention, saving the last log number and the last log number successfully transferred may enable each synchronization modules to resume synchronization from the last successful log transfer.

In accordance with some embodiments of the present invention, each synchronization module may include a peers table. The synchronization module may be configured to save or update in the peers table an entry for each of the peers it previously synchronized with, either directly or indirectly. In accordance with further embodiments of the present invention, each entry in the peers table may include an indication relating to the log number(s) which were thus far received or successfully synchronized. In accordance with further embodiments of the present invention, the synchronization module may be configured to save or update within the peers table for each peer data or an indication relating the synchronization module (or modules) with which it was previously synchronized with, either directly or indirectly, and an indication relating to the highest log numbers which was so far received or successfully synchronized with that peer (or from each of the peers it previously synchronized with).

In accordance with some embodiments of the present invention, whenever an activity log is received at any of the synchronization modules, the synchronization module may be configured to check the synchronization log to determine whether the log creator and the transmitting party are associated with the same identifier. In accordance with some embodiments of the present invention, if the synchronization module determines that the log creator and the transmitting party are associated with the same identifier, the synchronization module may be configured to save or update the data relating to the highest log number received for the particular synchronization module from which the log was received (the transmitting synchronization module). However, in accordance with some embodiments of the present invention, if the receiving synchronization module determines that in accordance with the data in the creator or originator field of the received activity log, the synchronization module which created the activity log is not the transmitting synchronization module from which the activity log was received and which is correlated with the identifier associated with the received activity log, the receiving synchronization module may be configured to create or update a peers table entry associated with the synchronization module which created the activity log. In accordance with further embodiments of the present invention, in addition, the synchronization module may be configured to save or update the last log number it successfully received from the synchronization module which created the activity log. The receiving synchronization module may be configured to save or update in the peers table the data associated with the synchronization module which created the activity log in addition to saving or updating the data relating to the transmitting synchronization module from which the activity was log was received at the receiving synchronization module.

Log records or entries received by a first synchronization module, running on a first device, from a second synchronization module, running on a second associated device, may be interpreted and the action(s) which was the source of each log record on the second device may be performed by the synchronization module on the first device. For example, if the first synchronization module receives from the second module a log record indicating the creation of a new data item unit (e.g. a new email was received or a new document was originated) on the second device, the first synchronization module may either request a copy of the data item whose content is correlated with the content of the new data unit, or may request access to the data item containing a pointer or link to a file or memory location containing the content correlated the new data unit. According to either of the above mentioned embodiments or methods, the received log record may contain the unique identifier of the relevant data item and the first computing device may utilize the identified data item to copy content correlated with the content of the new data unit from the second device to the first computing device and to create a corresponding (e.g. same) data unit on the first computing device.

According to some embodiments of the present invention, if the first synchronization module receives from the second module a log entry indicating the deletion of a data unit from the second device, the first synchronization module may delete the corresponding (e.g. same) data unit on the first computer. Also, if the first module receives from the second module a log entry indicating the amendment or alteration of a document or file represented by a data unit, the first synchronization module may use the data item indicted in the received activity log to retrieve content correlated with the altered data unit. The synchronization module of the first device may retrieve the content by retrieving the indicated data item itself, when the indicated data item includes the content, or by retrieving a file or stored memory from the second computing device to which the data item is pointing to, when the indicated data item is only a pointer or link.

According to some embodiments of the present invention, a data item referred to or indicated by an activity log record is not transferred to the device receiving the activity log record. According to such embodiments of the present invention, only the unique identifier of the data item associated with a given log record is transferred, either along with or as part of the activity log record. If the receiving synchronization module requires access to content referred to in a received log record, the synchronization module on the receiving device request may request the content from the synchronization module on transmitting device by providing the relevant data item's unique identifier. In turn, the synchronization module may either transmit content included in the relevant data item, if the data item includes that content, or it may locate the relevant content by following a pointer or link in the identified data item, when the data item is merely a link or pointer.

According to some embodiments of the present invention, not all alterations to a data unit may require or result in the creation of a new data item. If an alteration is made to a data unit prior to that data unit's associated data item being propagated (i.e. the data item itself or any log record containing the data item's unique identifier) to other devices, production of a new data item may not be required. In such cases, only amendments to the existing data item, in accordance with the amendments made to the data item's associated data unit, may be required. According to some embodiments of the present invention, a given data unit may require a new associated data item only when the data unit is altered after the device on which the unit resides has engaged in at least one synchronization process. Otherwise, the data item may be altered multiple times without the need to create a new data item. Furthermore, changes such as file name changes or any other changes to a data unit's property not associated directly with the content of data unit may also not require a new data item.

According to some embodiments of the present invention, data associated with a log record received by a first device from a second device may be recorded as a log record in a log of the first device. A log record associated with a received log record may include the unique identifier of the synchronization module that created that log.

A log record received by one device from a second device may pass the log record to a third device, and so on. Regardless of whether a log record is received from a device which originated the log record or from a device which is merely passing along a received log record, a device receiving the log record may store the received record along with an identifier of the synchronization module that created that log. Thus, according to some embodiments of the present invention, if an activity log is propagated through a group of associated devices (or through a group of associated synchronization modules), for example, an activity log which is received at a receiving device from a transmitting device which is not the originator or creator of the activity log, but rather received the activity log, directly or indirectly, from another device which originally created that activity log, the receiving device may be configured to check the identifier of the device which originated or created the activity log and the log number of that activity log in the device which created the activity log. As mentioned above, data relating to both the identifier of the device which originated or created the activity log and the log number of that activity log in the device which created the activity log may be included as part of each activity log received.

In accordance with some embodiments of the present invention, the receiving device or the receiving synchronization module may be adapted to determine in accordance with the identifier of the device which originated or created the activity log included in each activity log, whether the receiving device and the device that created that log have the same unique identifier, in which case, the synchronization module (or device) may be configured to ignore the received activity log. In accordance with further embodiments of the present invention, the receiving synchronization module may be adapted to determine in accordance with the identifier of the device which originated or created the activity log and the log number of that activity log in the originating device, whether the data in the peers table associated with the originating device indicates that the log number relating to the last successfully synchronized log already received, either directly or indirectly, from that originating device is lower than the activity log number in the device which created the received activity log, in such cases, the receiving synchronization module may be adapted to implement the log, otherwise the receiving module may be configured to ignore the received activity log.

In accordance with further embodiments of the present invention, the receiving synchronization module may be adapted to determine in accordance with the identifier of the device which originated or created the activity log and the log number of that activity log in the originating device, whether this activity log was already implemented by the receiving module. In accordance with further embodiments of the present invention, the receiving synchronization module may consult its peer table to determine whether a received activity log was already implemented by the receiving module. In accordance with yet further embodiments of the present invention, in case a receiving synchronization module determines that a certain activity log was already implemented by the receiving synchronization module, the synchronization module may consult its peer table to determine, which is the highest log number that is associated with the synchronization module which generated the implemented activity log. Once, the receiving synchronization module determines which is the highest log number which is associated with the synchronization module which generated the implemented activity log, the receiving synchronization module may be configured to request the transmitting synchronization module to transmit (to the receiving module) only activity logs whose originating synchronization module's log number is greater than the highest log number associated with the originating module which was implemented in the receiving module.

According to some embodiments of the present invention, should actions to be taken on a given data unit indicated by a received log record conflict with actions already taken locally on the corresponding data unit, the synchronization module on the receiving device may store all the available options for the resolution of the conflict and may prompt a user to resolve the conflict when the user attempts to access the document or file associated with the data unit.

It should be clear to one of ordinary skill in the art that the present invention is not limited to synchronization between two synchronization modules, but that one synchronization module may communicated and synchronize with a countless number of associated synchronization modules, either one at a time, or according to some embodiments of the present invention in parallel. A group of associated devices, each having a synchronization modules, may synchronize corresponding files or data items among all the devices of the group by propagating changes to the data items between devices, either two devices at a time, or according to some embodiments, by propagating changes made on a first device to several other devices in parallel.

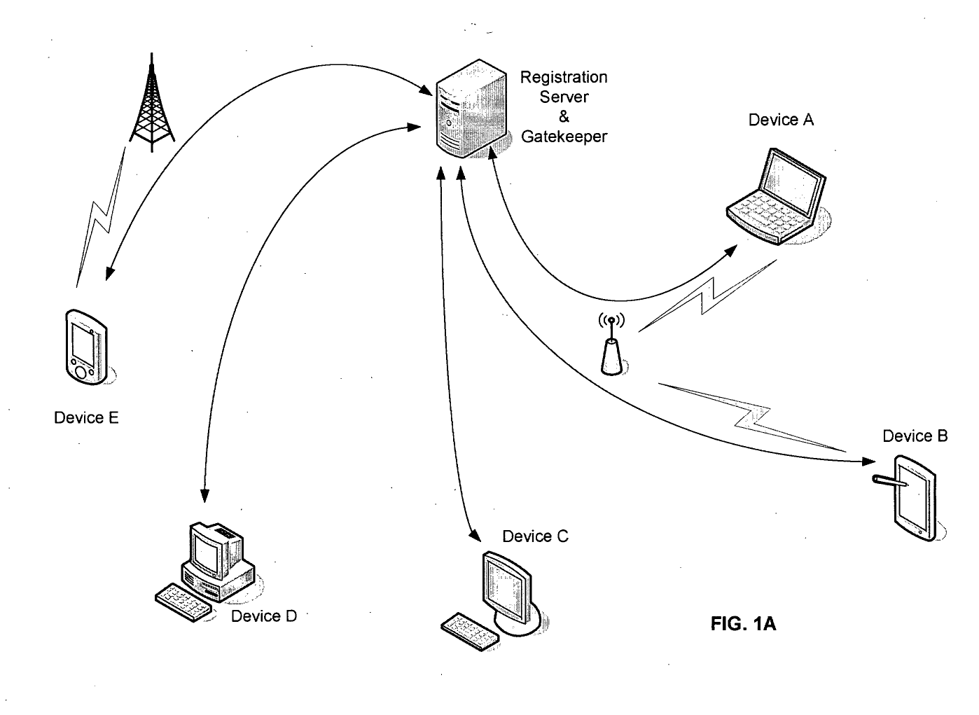

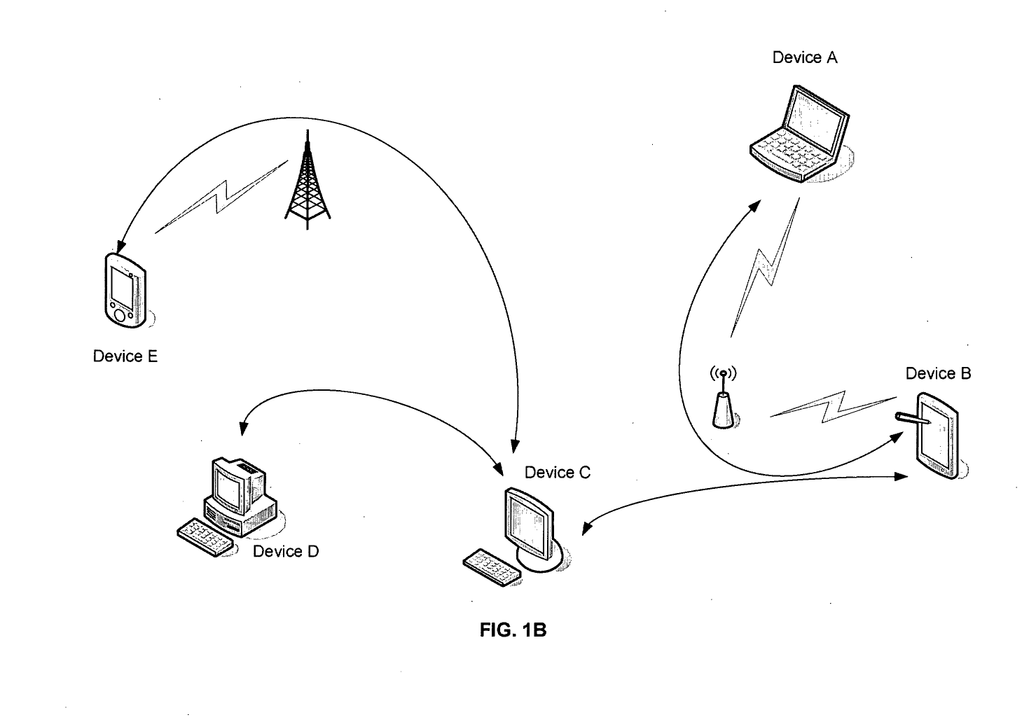

Turning now to FIG. 1A, there is shown a conception diagram illustrating how, according to some embodiments of the present invention, a each of a group of associated computing device may initiate a synchronization process with another associated computer, wherein as part of the synchronization process each computing device may access a registration server and/or gatekeeper so as to obtain connection information relating to one or more of the other computing device. Associated computing devices may be defined as devices which are all running a synchronization module according to some embodiments of the present invention, which synchronization modules have been configured to communicate amongst each other and to keep synchronize a certain data set, herein defined as corresponding data.

Corresponding data may include: (1) all files in a given directory or set of directories; (2) all file produced by a specific application or set of applications, including word processing applications, spread sheets, email clients, etc. . . . , and (3) any combination of the above two; or (4) any data produced by any data sources, stored by any data storage means or method, currently known today or to be devised in the future.

Although according to some embodiments of the present invention each computing device, vis-à-vis its respective synchronization module may have its own unique device identifier, since the computing devices may not be connected to a communication network, e.g. the Internet, through a permanent I.P. address, upon connecting to the network, each device may register with a registration server and may provide the server with sufficient information to allow associated devices to contact the registering device on a peer-to-peer basis. The server may act as a gatekeeper, granting or denying associated computing devices access to the registered device, by either providing or denying requesting devices the information needed to contact the registered device. The establishment and operation of peep-to-peer communication links is well known, and methodology, circuitry or software currently known or to be devised in the future for this purpose may be applicable to present invention.

Turning now to FIG. 1B, there is shown a conception diagram illustrating how, according to some embodiments of the present invention, each of a group of associated computing device may synchronize with one or more other associated computing devices in the group, on a peer-to-peer basis, without an intermediate server. Once a computing device has received sufficient contact information to contact another device which is currently connected to the same network, the two devices may synchronize on a peer-to-peer basis, without the need of an intermediate device.

According to some embodiments of the present invention, once a computing device synchronized with one associated device, it may connect to and synchronize with a second associated device. According to further embodiments of the present invention, one computing device may synchronize with two more associated devices in parallel.

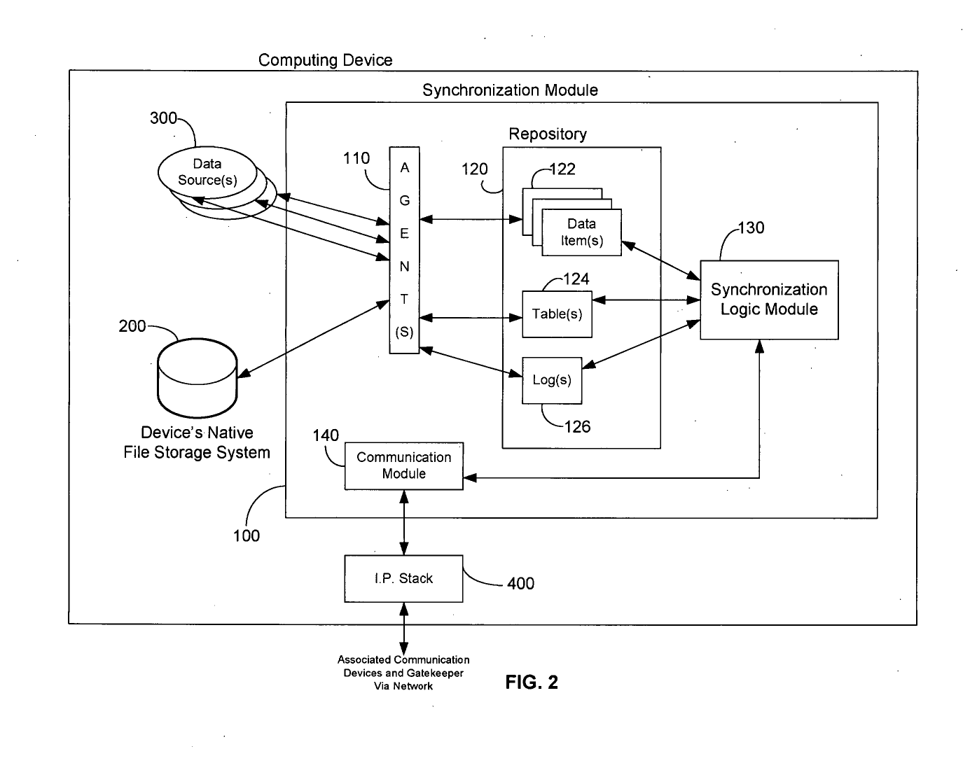

Turning now to FIG. 2, there is shown a block diagram illustrating various components of an exemplary data synchronization module 100 according to some embodiments of the present invention. The description below whereby an agent 110 or agents 110 are used for performing some of the functionalities of the synchronization module of the present invention, is purely exemplary in nature. It should be noted, that in accordance with some embodiments of the present invention, any of the functionalities performed by the agent 110 may be performed by the synchronization module 100 or, in accordance with further embodiments of the present invention, one or more of the agents described hereinbelow may be included as part of the synchronization module of the present invention.

As part of the synchronization module 100, software agents 110 may monitor activity performed by one or more data sources 300 (e.g. data producing software applications) running on the device. Based detected activity, the agents 110 may insert or update records in a data repository which may include activity data logs 126, data tables 124, and data items or files 122 whose data content is correlated with the data produced by the data source(s) 300. The agents 110 may also act as intermediary applications between the source applications 300 they are monitoring and the data files which the source applications 300 are storing to and accessing from a native file storage system 200. That is, each time a source application 300 attempts to store data to the native storage system 200, its associated agent 110 may intercept the data and may store the data through the synchronization module 100. Each time a source application 300 may attempt to access data stored on the native storage system 200, its agent may intercept the request and may provide the request data stored through the synchronization module 100. Methodology and software modules for monitoring other applications and for augmenting the data storage and retrieval processes of other applications are well known. Any such methodology, software or technology known today or to be devised in the future may be applicable to the present invention.

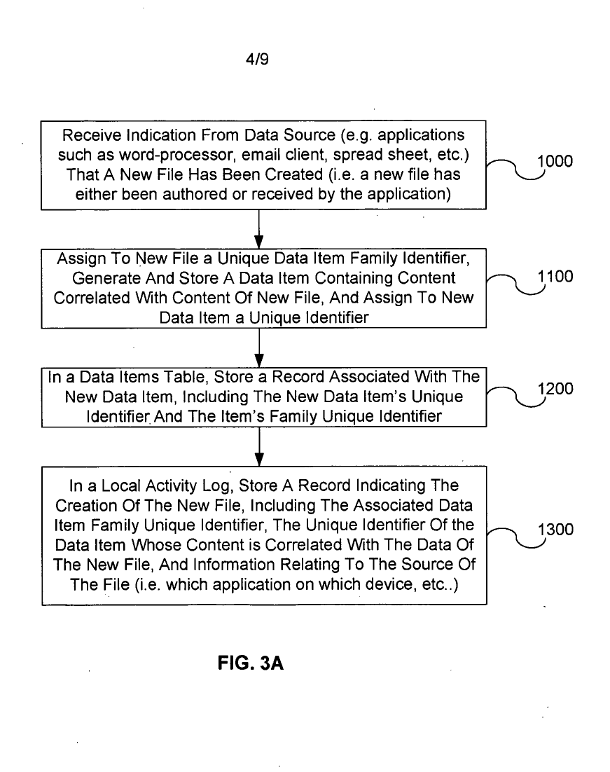

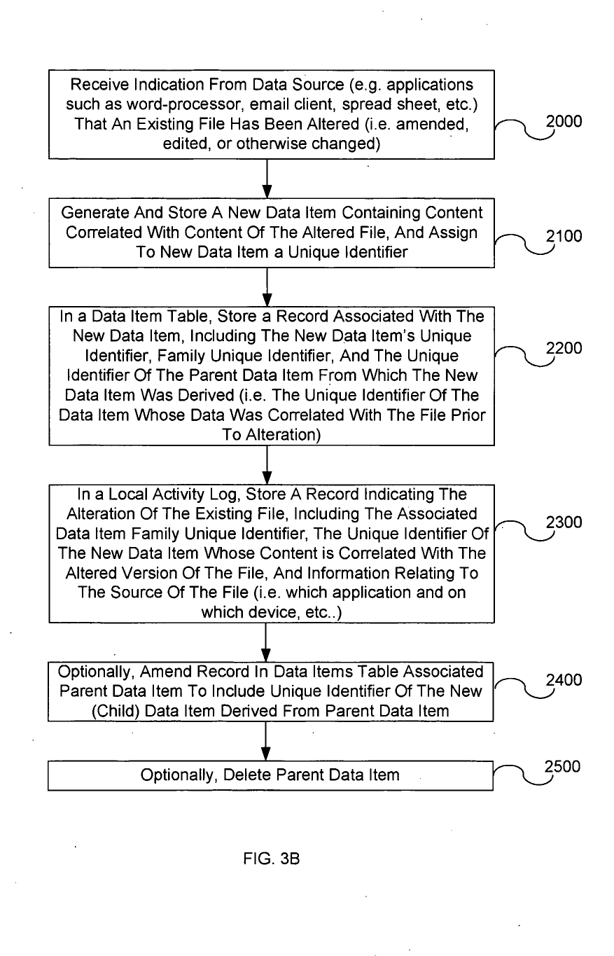

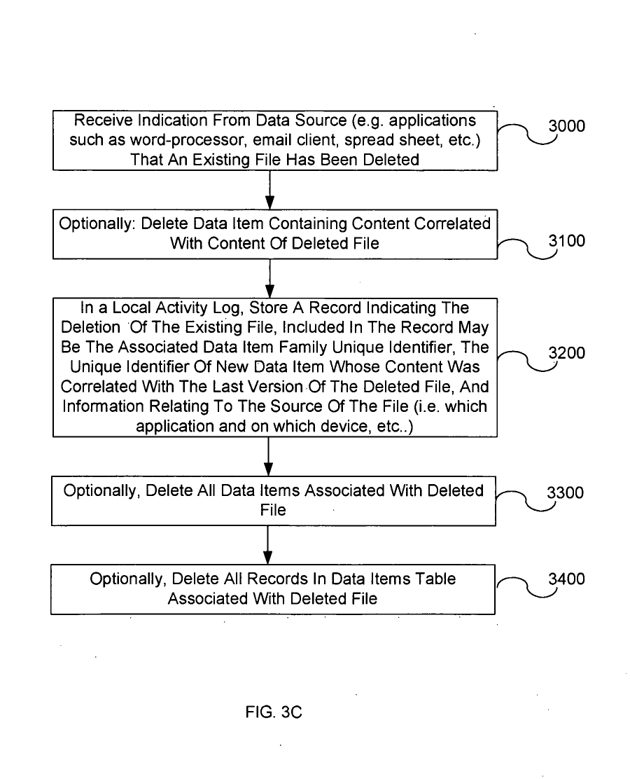

According to some embodiment of the present invention, when a source application 300 may produce new data, for example a new file such as a document, spread sheet or email, an agent 110 associated with the source application 300 may perform some or all of the step illustrated in FIG. 3A, which is a flow chart diagram illustrating the steps of an exemplary method of operating data tables, data logs and data items to be used during synchronization, on a computing device in response to the creation of a new data file on the computing device. More specifically, upon receiving an indication that a source application 300 is attempting to store a new data file (step 1000), the agent 110 may assign to the documents a unique data item family identifier that may be associated with additional fields, such as the source application type and the synchronization module data type, as well as additional fields related to the handling of the items by the synchronization module, the agent 110 may also produce and store a data item 122 which has data correlated to the file (e.g. substantial copy of the file) and may assign the data item a unique identifier (step 1100). The agent 110 may also produce a record in a data items table 124 associated with the newly created data item (step 1200), which data items table record may include the data item's unique identifier and that of its family. In a local activity log 126, the agent 110 may store a record indicating the creation of the new file, including the associated data item family unique identifier, the unique identifier of the data item whose content is correlated with the data of the new file, and Information relating to the source of the file (i.e. which application on which device, etc. . . . ).

The agent 110 may or may not use the native file storage system 200. The copy of file a given source application 300 attempts to store may actually be created in the native storage system 200, or may only exist as a “virtual file,” whose content is controlled by the synchronization module 100. The term “virtual file” refers to, for example, a shortcut or link from where the actual file is supposed to be stored (i.e. the native storage system) to a data item which may contain the actual data, where the content in the data item is subject to modification by the synchronization module 100.

The exact data structure of each of the above mentioned logs, tables and data items is not critical, and one of ordinary skill in the art may devise countless such data structures, each of which would be applicable to the present invention. Exemplary data structures are shown directly below. Assuming each data item has a Globally Unique Identifier (“GUID”) to identify it across multiple synchronization module running on associated devices, data about the items may be stored in a repository in two data base tables:
Data Items Table—may contain a single record for each data item. The columns in this table are common to all data items and also describe the hierarchy of items, where each data item has one parent and may have any number of child items. Each data item in this table may have a unique Data Item ID.
Fields Values Table—contains one record for each field value of a data item. The field value is related to its data item by the Data Item ID.

The description below uses the term agent for illustration purposes only, any of the functionalities performed by the agent may be performed by the synchronization module and/or one or more of the agents described hereinbelow may be included as part of the synchronization module of the present invention.

Fields in the Data Items Table

| Field Name | Field Type | Comments |
|---|---|---|
| Item Guid | GUID | Generated and assigned to each new Data |
| | | Item |
| Parent Guid | GUID | Describes the above Parent ID for |
| | | replication purposes |
| Class ID | GUID | The class ID of this DataItem. |
| | | This class ID is given by the Agent that |
| | | creates the Data Item and provides |
| | | information regarding to the manner by |
| | | which this Data Item is handled by the |
| | | synchronization module 100 |
| Type Class ID | GUID | Information relating to the data source 300 |
| | | associated with the Data Item |
| Agent Guid | GUID | Agent Guid is the GUID of the Agent |
| | | responsible for the Data Item |
| Agent Item ID | String | Agent provide this value (item's unique |
| | | identifier for this agent) |
| | | An Agent uses this field to correlate |
| | | DataItems between the Repository and the |
| | | Data Source. |
| Name | String | Name is the native name of the Data Item in |
| | | its source, as given to it by the Agent |
| | | responsible for it. |
| | | Used only for display purposes. |
| | | Does not have to be unique. |
| Has Data | Boolean | Indicates if this DataItem has data (false: |
| | | when this item's data need to be synced) |

Fields in the Fields Values Table

| Field Name | Field Type | Comments |
|---|---|---|
| Data Item ID | GUID | Relates to Data Items −> Item Guid |
| Field ID | Number | Relates to Field ID in the Class Info |
| | | object of this Data Item (provided by |
| | | the Agent which has created it) |
| Instance | Number | Uses for cases that a field is a list/array, |
| | | then we would like to “hang” few values |
| | | on it (for example: putting few values on |
| | | the attachment field in the email Data Type) |
| Field Type | Number | The actual field type used |
| Pointer Value | GUID | |
| String Value | String | |
| Num Value | Number | |
| Date Value | Time-Date | |
| Boolean Value | Boolean | |
| Double Value | Double | |

The log may be the basis for synchronization, and is comprised of the list of events as received from the Agents 110. Using the log may enable the synchronization module to be independent of the individual system clock. An inaccurate clock on one PC may not interfere with the synchronization process or cause conflicts in the objects to be synchronized. The log may be comprised of the following key fields: (a) a sequential log number; (b) a unique system-wide ID (GUID) for the object; (c) the modification made (insert, update, delete); and (d) originating Pod; and (e) log number of originating Pod.

Log Table

| Name | Type | Description |
|---|---|---|
| Log Number | <Auto Number> | An integer that is a running |
| | | number of the records in the |
| | | table. This number is incremented |
| | | for each record inserted. |
| | | It is used as the Log Number in the |
| | | Peers Table. (see protocol below) |
| Item Guid | GUID | A unique id of the record in |
| | | the Data Items table that has |
| | | changed. Relate to Data Items |
| | | Table -> Item Guid |
| Mod Type | NUMBER | An integer code of the change. |
| | | {insert, update, delete} |
| Owner Guid | GUID | DataPod ID where the record |
| | | was modified. This is the local |
| | | pod ID if the change was made |
| | | locally. If the change is a |
| | | result of a synch with another pod |
| | | then it is some other pod's ID. |
| Owner Log Num | NUMBER | The Log Number received from |
| | | the DataPod that modified the |
| | | Data Item. If the modification |
| | | is made locally then this number |
| | | is equal to the Log Number field |
| | | of this record. |
| Modifier Agent | GUID | Class GUID of the agent that made |
| | | the change |

The below table may store the actual changes recorded in the Log Table in records of type Update. When there is a modification request, a log record may be created that describes the modification. If the modification is of a type “Update”, the modified field values may be written to this table with the log number of the Log record. When a synchronization log change is prepared, the fields related to each log record may be sent with the log record. The receiver of the log change use these values to updates its own repository or logs.

Log Details Table

| Field Name | Field Type | Comments |
|---|---|---|
| Log Number | Number | Relates to Log Number field in the |
| | | Log table |
| Field ID | GUID | Relates to Field ID in the Class Info |
| | | object of this Data Item (provided by |
| | | the Agent which has created it) |
| Instance | Number | Uses for cases that a field is a list/array, |
| | | then we would like to “hang” few values |
| | | on it (for example: putting few values on |
| | | the attachment field in the email Data Type) |
| Pointer Value | GUID | GUID value |
| String Value | String | string value |
| Num Value | Number | integer value |
| Date Value | Time-Date | data value |
| Boolean Value | Boolean | boolean value |

In accordance with some embodiments of the present invention, each device may be configured to keep information about the other devices it is familiar with or which it knows about (for example, devices with which it previously synchronized, directly or indirectly), in relation to log numbers (for successfully delivered logs).

Peers Table

| Field Name | Field Type | Comments |
|---|---|---|
| PeerID | GUID | GUID of Peer. |
| | | This field represents a DataPod |
| | | installation on one device (PC, |
| | | Laptop, PDA) |
| ShareGuid | GUID | The guid of specific share for |
| | | this entry |
| SyncInLogNumber | NUMBER | Last log number that was received |
| | | from this DataPod and successfully |
| | | synched. |
| | | Used in request for updates. |
| SyncOutLogNumber | NUMBER | Last log number that this DataPod |
| | | reported to have successfully |
| | | synched. Used in log management. |

Upon receiving an indication from a source application 300 that an existing file has been amended and/or otherwise altered, an associated agent 110 may perform some or all of the steps shown in FIG. 3B, which is a flow chart diagram illustrating the steps of an exemplary method of operating data tables, logs and items to be used during synchronization, on a computing device in response to the alteration of an existing data file on the computing device. Upon receiving such indication (step 2000) the agent 110 may generate and store a new data item containing content correlated with the content of the altered file, and may assign to new data item a unique identifier (step 2100). In a data items table 124, the agent 110 may store a record associated with the new data item, including the new data item's unique identifier, family unique identifier, and the unique identifier of the parent data item from which the new data item was derived, i.e. the unique identifier of the data item whose data was correlated with the file prior to alteration (step 2200).

Furthermore, in a local activity log 126, the agent 110 may store a record indicating the alteration of the existing file, including the associated data item family unique identifier, the unique identifier of the new data item whose content is correlated with the altered version of the file, and Information relating to the source of the file, i.e. which application and on which device the alternation originated (step 2300).

Optionally, the agent 110 may amend a record in data items table associated the parent data item to include unique identifier of the new (Child) data item derived from the parent data item (step 2400), and may even delete the parent data item (step 2500).

Upon receiving an indication from a source application 300 that an existing file has been deleted, an associated agent 110 may perform some or all of the steps shown in FIG. 3C, which is a flow chart diagram illustrating the steps of an exemplary method of operating data tables, logs and items to be used during synchronization, on a computing device in response to the deletion of a data file on the computing device. Upon receiving such an indication (step 3000), agent 110 may store a record in a local activity log 126 indicating the deletion of the existing file. Included in the record may be the associated data item family unique identifier, the unique identifier of new data item whose content was correlated with the last version of the deleted file, and information relating to the source of the file, i.e. which application and on which device, etc. . . . (step 3200). Optionally, the agent 110 may delete the data item (step 3100), all the related data items (step 3300) and all records in the data items table associated with the deleted file (step 3400).

Although reference was continually made to an agent 110 or agents 110 performing many of the above mentioned steps, it should be clear to one of ordinary skill in the art that the term agent may refer to one or a set of computer applications operating and cooperating on the same device or on several devices. Some of the above reference functions or steps may be performed by synchronization module or by any other software modules, such as the synchronization logic module 130 shown in FIG. 2. For example the synchronization module may incorporate one or more components of the agents themselves.

It should be further noted that the synchronization module may include any number necessary hardware or software component to perform the functions described below.

Turning back to FIG. 2, there is also shown a synchronization logic module 130, which module may have access to all the data tables, logs and items stored in a data repository according to some embodiments of the present invention. The synchronization logic module 130 may also be able to communicate with other synchronization modules, running on associated devices, through a data network and with the aid of an I.P. stack which may be part of the device upon which the synchronization logic module 130 is running. It should be further noted that the synchronization module may be adapted to perform some or all of the functions performed by the synchronization logic module, and may include any necessary software and/or hardware components for performing these fundtions.

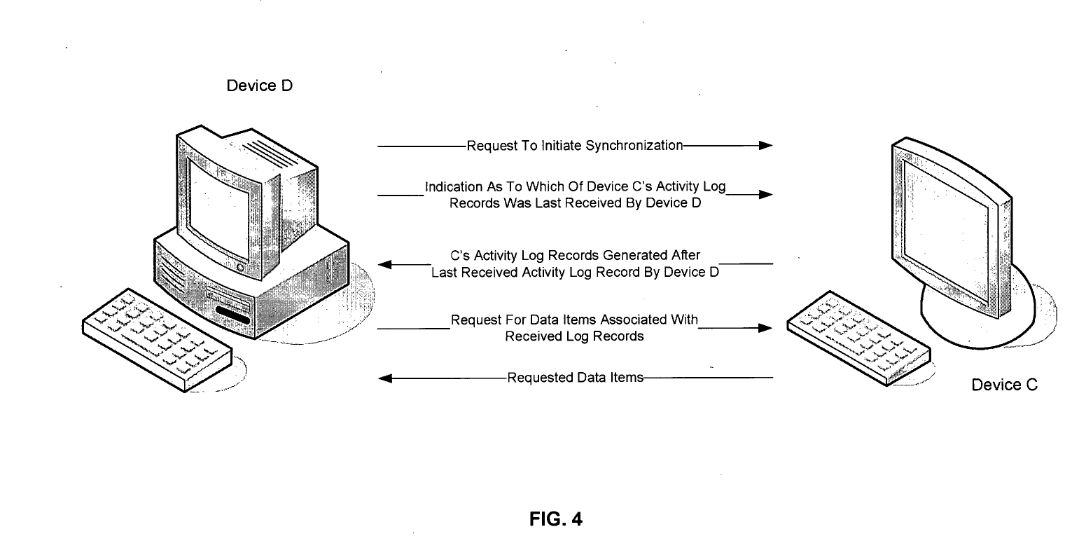

Turning now to FIGS. 4, there is shown a conceptual block diagram illustrating an exemplary flow of data between two computing devices engaging in a synchronization process, vis-à-vis their respective synchronization modules, according to some embodiments of the present invention. Initiation of a synchronization process may be triggered by either one of the computing devices, C or D, although FIG. 4 shows an example where D initiates the synchronization process. According to some embodiments of the present invention, D may be the initiator of the process because device D may have just connected to the network to which C was already connected to, and the synchronization module 100 on device D may be attempting to retrieve the most updated corresponding data from device C and all other associated devices currently connected to the network.

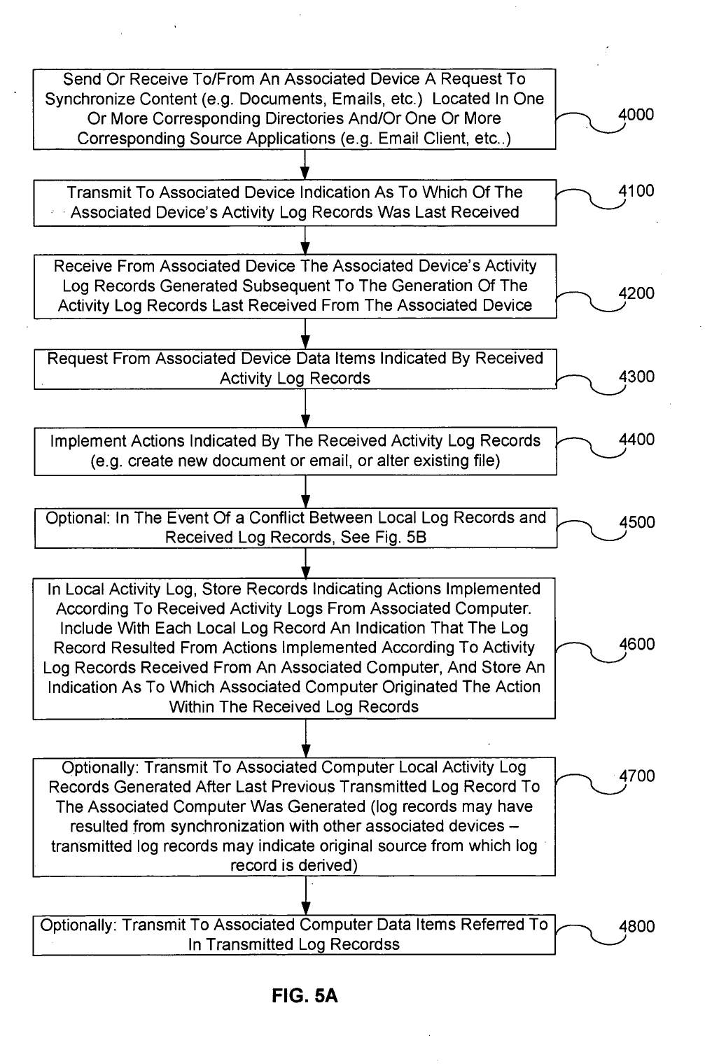

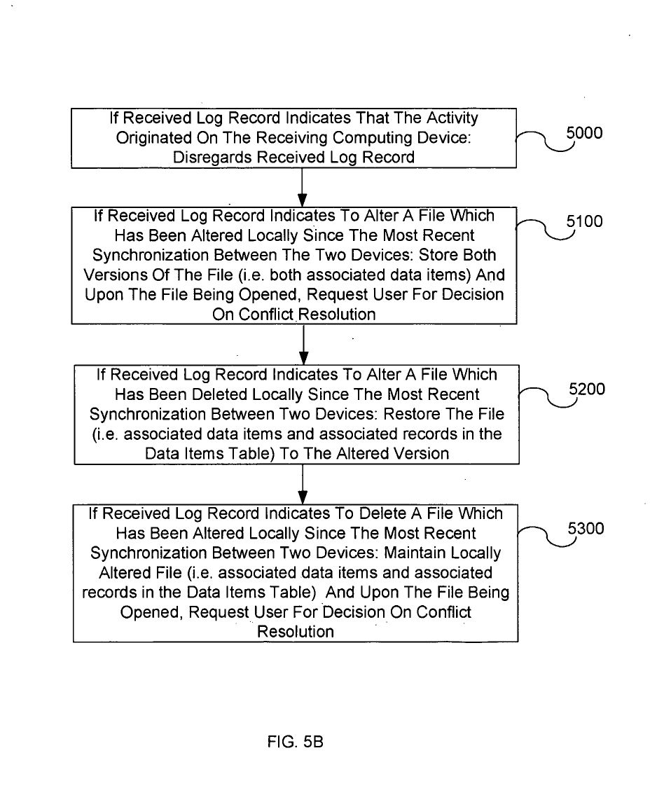

Data flow and synchronization between two associated devices, such as the ones shown in FIG. 4, may flow some or all of the steps of the method illustrated in FIG. 5A, a flow diagram illustrating the steps of an exemplary method of synchronizing corresponding data between two associated computing devices. More specifically, after triggering or initiating a synchronization process (step 4000) with an associated computing device, which in the example of FIG. 4 is device C, the synchronization module 100 on the device which triggered the synchronization (device D) may provide the associated device (device C) an indication (step 4100) as to which was the last activity log record the initiating device (device D) received from the associated device (device C). In response, to receiving such indication, the associated device (device C) may transmit and the device D may receive (Step 4200) one ore more of device C's activity log records which were produced subsequent to the production of the last activity log record which was receive by the computing device (device D).

According to some embodiment of the present invention, along with transmitting activity log(s), the transmitting device may also transmit all associated data items. However, according to other embodiments of the present invention, the device receiving the activity log(s) may review the received log(s) and compare the data items referred to in the logs with data items stored locally and may only request those data items which are not currently stored locally (step 4300).

Once a computing device has the activity log record(s) and associated data items of an associated device (step 4500), the device's synchronization module 100 may reconstruct any new files produced or any new alterations made to existing files on the associated device which were in predefined directories or produced by a predefined source application, and are thus defined as corresponding data. Once a device's synchronization module 100 has executed an action according to a received data log record, or currently with executing the action, a log record indicating the executed action may be entered in the device's activity log (step 4600). According to some embodiments of the present invention, any entry of a record in a device's local activity log resulting from activity performed in accordance from a log record received from an associated computing device may contain an indication that the action originated at another computing device. According to further embodiments of the present invention, each log record propagated between associated computing devices may contain an indication (e.g. unique identifier) of the computing device on which it originated. Thus, if device D receives and acts upon a log record originated on device C, when a log record of the action taken on device D is inserted in the log of device D, that log record will indicate that the action originated on device C. If the received log record from device C indicates that the original action was originate not on device C, but rather on another device with which device C synchronized (e.g. Device A), than when a log record of the action taken on device D is inserted in the log of device D, that log record will indicate that the action originated on device A.

It should be clear to one of ordinary skill in the art that the exact series of steps and the direction data flows may modified without departing from the spirit of the invention. For example, it is not important which of two or more associated devices initiates a synchronization process. Although one device may initiate the synchronization, the second device may be the first to received logs and data items from the initiating device. According to some embodiments of the present invention, after synchronization is initiated, regardless of which device initiates it, each device may receive the other's relevant data logs and data items (steps 4700 and 4800). According to other embodiments of the present invention, data logs and data items may be received by only a subset of the associated computing devices participating in a synchronization process.

In the event that a received log record indicated the creation of a new file, an associated data item may be used to reproduce the file locally. In the event that a log record indicates the alteration of an existing file which existed in the same version on both devices (e.g. both computers had version 4 of a documents and the received log indicated that on device C version 4 was edited to produce version 5), the synchronization module 100, may simply make the indicated alterations and may use the received data item associated with the alteration to implement the alteration locally, possibly by replacing a locally store data item with the newly received data item associated with the log record indicating the alteration.

There are cases when there exists a conflict between an action indicated by a received log and the current state of the files, data log records and/or data items on the receiving device (step 4500). Turning now to FIG. 5B, there is shown a flow diagram illustrating the steps of an exemplary method of resolving certain conflicts as part of the synchronization of corresponding data between two associated computing devices, according to some embodiments of the present invention. In the event a received log record indicates that the action associated with the record originated on the receiving computing device, the log record may be ignored or discarded (step 5000). For example, if the received log record indicates an alteration to a version of an existing file which has been altered locally since the last synchronization process between the two devices, the synchronization module 100 may store the data logs and data items associated with both the latest local version and the version associated with the received log record (step 5100). According to some embodiments of the present invention, the synchronization module 100 may prompt a user to resolve the conflict once the user attempts to access the file associated with the received log record. If the received log record indicates an alteration to a file which has been deleted locally, the synchronization module 100 may restore the data logs and data items associated with the deleted file using the newly received log records and data items (step 5200). If on the other hand the received log record indicates a deletion of an existing file which has already been altered locally since the last synchronization process between the two devices, the synchronization module 100 may request the user to resolve the conflict next time the user attempts to access the relevant file (step 5300).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1.-50. (canceled)

51. A method of synchronizing data from a synchronization application to one or more associated synchronization applications, said method comprising:
creating a data item in response to an action executed on a data unit, said data item being associated with a substantially unique identifier;
creating an activity log in response to an action executed on the data unit, said activity log including the substantially unique identifier associated with the data item and an ascending log number;
propagating the activity log to one or more of the associated synchronization applications.

52. The method according to claim 51, wherein said creating a data item comprises, creating the data item in response to a non-data-deleting action executed on the data unit, and wherein said creating an activity log comprises creating the activity log in response to an action including a data-deleting or a non-data-deleting action executed on the data unit.

53. The method according to claim 52, wherein said creating further comprises associating the activity log with a substantially unique identifier corresponding to the synchronization application which created the activity log and with the ascending log number of the activity log at the synchronization application which created the activity log.

54. The method according to claim 53, further comprising receiving an activity log and associating the received activity log with a substantially unique identifier corresponding to the transmitting synchronization application from which the activity log was received.

55. The method according to claim 54, further comprising discarding the received activity log in case it is determined that the identifier corresponding to the synchronization application which created the received activity log is identical to the identifier corresponding to the receiving synchronization application.

56. The method according to claim 54, further comprising obtaining a recorded log number of the last activity log received from the synchronization application which created a received activity log in case it is determined that the identifier corresponding to the synchronization application which created the received activity log is not identical to the identifier corresponding to the transmitting synchronization application nor to the identifier corresponding to the receiving synchronization application.

57. The method according to claim 51, further comprising recording in each synchronization application the log number of the last activity log which was received from each of the associated synchronization applications.

58. The method according to claim 57, further comprising for each activity log received in a synchronization application, recording the ascending log number of the activity log at the synchronization application which created the activity log.

59. The method according to claim 58, further comprising for each of the associated synchronization applications, recording the log number of the last activity log which was transmitted to that synchronization application.

60. The method according to claims 56, further comprising comparing the recorded log number of the last activity log received from the synchronization application which created the received activity log with the ascending log number of the activity log at the synchronization application which created the received activity log.

61. The method according claim 60, further comprising implementing the received activity log in case it is determined that the ascending log number of the activity log at the synchronization application which created the received activity log is greater than the recorded log number of the last activity log received from the synchronization application which created the received activity log.

62. The method according to claim 60, further comprising discarding the received activity log in case it is determined that the ascending log number of the activity log at the synchronization application which created the received activity log is not greater than the recorded log number of the last activity log received from the synchronization application which created the received activity log.

63. The method according to claim 60, further comprising requesting the transmitting synchronization application to send activity logs created by the synchronization application which created the received activity log whose log number is greater than the log number recorded at the receiving synchronization application for the last implemented activity log created by the synchronization application which created the received activity log.

64. The method according to claim 61, wherein said implementing further comprises:
associating the implemented activity log with the ascending log number of the receiving synchronization application in addition to the substantially unique identifier associated with the data item; and
associating the implemented activity log with the substantially unique identifier corresponding to the synchronization application which created the activity log, and with the ascending log number of the synchronization application which created the activity log.

65. The method according to claim 64, wherein each of the associated synchronization applications may be synchronized with each of the other associated synchronization applications.

66. The method according to claim 61, wherein said implementing comprises one or more of the following:
creating a data item corresponding to the received activity log in case the activity log is associated with creating a new data unit;
updating a data item corresponding to the received activity log in case the activity log is associated with updating an existing data unit; and
deleting a data item in case the activity log is associated with a deletion of an existing data unit.

67. The method according to claim 66, wherein said creating a data item corresponding to the received activity log comprises processing the data item to determine whether the implemented data item is associated with supplemental data.

68. The method according to claim 67, further comprising retrieving the supplemental data from one or more of the associated synchronization applications.

69. The method according to claim 66, wherein said updating a data item corresponding to the received activity log comprises processing the data item to determine whether the implemented data item is associated with supplemental data.

70. The method according to claim 68, further comprising retrieving the supplemental data from one or more of the associated synchronization applications.

71. An apparatus for synchronizing data from a synchronization module to one or more associated synchronization modules, said apparatus comprising:
a synchronization module adapted to create a data item in response to an action executed on a data unit, and to associate the data item with a substantially unique identifier, said synchronization module being further adapted to create an activity log in response to an action executed on the data unit, and to associate the activity log with the substantially unique identifier associated with the data item and with an ascending log number,
wherein said synchronization module is adapted to cause the activity log to be propagated to one or more of the associated synchronization modules.

72. The apparatus according to claim 71, wherein said synchronization module is adapted to create the data item in response to a non-data-deleting action executed on a data unit, and wherein said synchronization module is adapted to create the activity log in response to a data-deleting or a non-data-deleting action executed on the data unit.

73. The apparatus according to claim 72, wherein said synchronization module is adapted to associate the activity log with a substantially unique identifier corresponding to a synchronization module which created the activity log and with the ascending log number of the activity log at the synchronization module which created the activity log.

74. The apparatus according to claim 73, wherein said synchronization module is further adapted to receive an activity log and to associate the received activity log with a substantially unique identifier corresponding to a transmitting synchronization module from which the activity log was received.

75. The apparatus according to claim 74, wherein said synchronization module is adapted to discard the received activity log in case it is determined that the identifier corresponding to the synchronization module which created the received activity log is identical to the identifier corresponding to the receiving synchronization module.

76. The device according to claim 74, wherein said synchronization module is adapted to obtain a recorded log number of the last activity log received from the synchronization module which created the received activity log in case it is determined that the identifier corresponding to the synchronization module which created the received activity log is not identical to the identifier corresponding to the transmitting synchronization module nor to the identifier corresponding to the receiving synchronization module.

77. The apparatus according to claim 71, further comprising a peers table, and wherein said synchronization module is adapted to record in said peers table the log number of the last activity log which was received from each of the associated synchronization modules.

78. The apparatus according to claim 71, wherein for each activity log received, said synchronization module is adapted to record in said peers table the ascending log number of the activity log at the synchronization module which created the activity log.

79. The apparatus according to claim 78, wherein for each of the associated synchronization modules, said synchronization module is adapted to record in said peers table the log number of the last activity log which was transmitted to that synchronization module.

80. The apparatus according to claim 76, wherein said synchronization module is adapted to compare the recorded log number of the last activity log received from the synchronization module which created the received activity log with the ascending log number of the activity log at the synchronization module which created the received activity log.

81. The apparatus according to claim 80, wherein said synchronization module is adapted to implement the received activity log in case it is determined that the ascending log number of the activity log at the synchronization module which created the received activity log is greater than the recorded log number of the last activity log received from the synchronization module which created the received activity log.

82. The apparatus according to claim 80, wherein said synchronization module is adapted to discard the received activity log in case it is determined that the ascending log number of the activity log at the synchronization module which created the received activity log is not greater than the recorded log number of the last activity log received from the synchronization module which created the received activity log.

83. The apparatus according to claim 80, wherein said synchronization module is adapted to request the transmitting synchronization module to send activity logs created by the synchronization module which created the received activity log whose log number is greater than the log number recorded at the receiving synchronization module for the last implemented activity log created by the synchronization module which created the received activity log.

84. The apparatus according to claim 81, wherein said synchronization module is adapted to associate the implemented activity log with the ascending log number of the receiving synchronization module in addition to the substantially unique identifier associated with the data item, and wherein said synchronization module is further adapted to the implemented activity log with the substantially unique identifier corresponding to the synchronization module which created the activity log, and with the ascending log number of the synchronization module which created the activity log.

85. The apparatus according to claim 84, wherein each of the associated synchronization modules may be synchronized with each of the other associated synchronization modules.

86. The apparatus according to claim 81, wherein as part of implementing the received activity log, said synchronization module is adapted to act upon a data item corresponding to the received activity log according to one or more of the following:
create a data item corresponding to the received activity log in case the activity log is associated with creating a new data unit;
update a data item corresponding to the received activity log in case the activity log is log is associated with updating an existing data unit.
delete a data item in response to an activity log created in response to a data-deleting action executed on a data unit.

87. The apparatus according to claim 86, wherein as part of creating a data item corresponding to the received activity log, said synchronization module is adapted process the data item to determine whether the implemented data item is associated with supplemental data.

88. The apparatus according to claim 87, wherein said synchronization module is adapted to retrieve the supplemental data from one or more of the associated synchronization modules.

89. The apparatus according to claim 86, wherein as part of updating a data item corresponding to the received activity log, said synchronization module is adapted process the data item to determine whether the implemented data item is associated with supplemental data.

90. The apparatus according to claim 89, wherein said synchronization module is adapted to retrieve the supplemental data from one or more of the associated synchronization modules.

91. The apparatus according to claim 71, wherein as part of creating the data item, said synchronization module is adapted to determine whether the new data item is derived from another data item.

92. The apparatus according to claim 91, wherein, in case the synchronization module determines that the new data item is derived from another data item, said synchronization module is adapted to further associate the new data item with a substantially unique identifier corresponding to the data item from which the new data item is derived.

93. The apparatus according to claim 91, wherein said synchronization module is adapted to determine that a new data item is derived from another data item when the new data item and the data item from which it is derived are created in response to corresponding actions executed on the same data unit.

94. The apparatus according to claim 93, wherein said synchronization module is adapted to determine that a new data item is derived from another data item when the new data item is created in response to a non-data-deleting action executed on the data unit.
